(19) United States
(12) Patent Application Publication
(10) Pub. No.: US 2020/0354046 A1
(43) Pub. Date: Nov. 12, 2020

(54) Differential Rotor Speed Resonance Avoidance System

(71) Applicant: Bell Textron Inc., Fort Worth, TX (US)

(72) Inventors: Jonathan A. Knoll, Burleson, TX (US); Jouyoung Jason Choi, Southlake, TX (US); Thomas Clement Parham, Colleyville, TX (US)

(73) Assignee: Bell Textron Inc., Fort Worth, TX (US)

(21) Appl. No.: 16/409,605

(22) Filed: May 10, 2019

(51) Int. Cl. B64C 27/00; B64C 27/32; B64C 13/16; H02P 25/02

(52) U.S. Cl. CPC B64C 27/001; B64C 27/32; B64C 27/28; H02P 25/02; B64C 13/16

(57) ABSTRACT

An aircraft having a differential rotor speed resonance avoidance system. The aircraft includes an airframe having structural elements subject to resonant vibration at critical frequencies. A thrust array is coupled to the airframe. The thrust array includes at least four rotor systems distributed about the airframe, each rotor system operable over a range of rotor speeds. A flight control system is operably associated with the thrust array and is configured to independently control the rotor speed of each rotor system. While preserving flight dynamics during flight operations, the flight control system selectively increases the rotor speed of some of the rotor systems by a speed delta and decreases the rotor speed of others of the rotor systems by the speed delta to avoid generating excitation frequencies by the rotor systems at the critical frequencies.

### TECHNICAL FIELD OF THE DISCLOSURE

The present disclosure relates, in general, to multirotor aircraft that utilize variable rotor speed to control flight dynamics and, in particular, to multirotor aircraft that utilize differential rotor speed to avoid generating frequencies that excite natural frequencies of structural elements of the aircraft.

### BACKGROUND

Physical structures have natural frequencies of vibration that can be excited by forces applied thereto as a result of operating parameters, environmental conditions or other inputs. These frequencies are determined, at least in part, by the stiffness, mass and geometric configuration of the structures. One important operating parameter of a rotorcraft is the angular velocity or revolutions per minute (RPM) of the rotor blades, which may generate excitation frequencies corresponding to 1/rev (1 per revolution), 2/rev, 3/rev, etc. As an example, if a rotor system has an operating speed of 360 RPM, the corresponding 1/rev excitation frequency is 6 Hertz (360/60=6 Hz). Similarly, the corresponding 2/rev excitation frequency is 12 Hz and the corresponding 3/rev excitation frequency is 18 Hz. As the operating speed of a rotor system changes, there is a proportional change in the excitation frequencies generated by that rotor system. In the case of modern rotorcraft, certain structures having critical natural frequencies may include the fuselage, the wings, the tail and various elements of the rotor systems. In the event an excitation frequency couples to a natural frequency of one of these structures, the affected structure can become unstable, leading to excessive vibration or even structural failure. Accordingly, there is a need to avoid exciting the natural frequencies of critical structural elements of a rotorcraft during flight.

### SUMMARY

In a first aspect, the present disclosure is directed to an aircraft having a differential rotor speed resonance avoidance system. The aircraft includes an airframe having structural elements subject to resonant vibration at critical frequencies. A thrust array is coupled to the airframe that includes at least four rotor systems distributed about the airframe. Each of the rotor systems is operable over a range of rotor speeds. A flight control system is operably associated with the thrust array and is configured to independently control the rotor speed of each rotor system. While preserving flight dynamics during flight operations, the flight control system selectively increases the rotor speed of some of the rotor systems by a speed delta and decreases the rotor speed of others of the rotor systems by the speed delta to avoid generating excitation frequencies by the rotor systems at the critical frequencies.

In some embodiments, the thrust array may include a forward-port rotor system, a forward-starboard rotor system, an aft-port rotor system and an aft-starboard rotor system. In other embodiments, the thrust array may include a forward-port rotor system, a forward-starboard rotor system, a mid-port rotor system, a mid-starboard rotor system, an aft-port rotor system and an aft-starboard rotor system. In certain embodiments, the rotor systems may be ducted rotor systems or may be open rotor systems. In some embodiments, the rotor systems may have rotor blades selected from the group consisting of fixed pitch rotor blades or variable pitch rotor blades. In certain embodiments, the structural element subject to resonant vibration may include fuselage structure, wing structure, tail structure, rotor system structure.

In some embodiments, the speed delta may include a first speed delta and a second speed delta. In such embodiments, the flight control system may increase the rotor speed of at least two rotor systems by the first speed delta, decreases the rotor speed of at least two rotor systems by the first speed delta, increases the rotor speed of at least one rotor system by the second speed delta and decreases the rotor speed of at least one rotor system by the second speed delta to avoid generating excitation frequencies by the rotor systems at the critical frequencies. In certain embodiments, the speed delta may include a resonance avoidance component and one or more of a pitch component, a roll component or a yaw component. During differential rotor speed resonance avoidance operations, total lateral forces may remain unchanged, total fore/aft forces may remain unchanged, total altitude forces may remain unchanged, total pitch moments may remain unchanged, total roll moments may remain unchanged and/or total yaw moments may remain unchanged, thereby preserving flight dynamics. In some embodiments, the critical frequencies may be preprogrammed into the flight control system. Alternatively or additionally, the aircraft may include a vibration sensor system and a vibration analyzing engine configured to receive vibration data from the vibration sensor system during flight and configured to identify the critical frequencies for the flight control system.

In a second aspect, the present disclosure is directed to an aircraft having a differential rotor speed resonance avoidance system. The aircraft includes an airframe having structural elements subject to resonant vibration at critical frequencies. A thrust array is coupled to the airframe that includes a forward-port rotor system, a forward-starboard rotor system, an aft-port rotor system and an aft-starboard rotor system. A flight control system is operably associated with the thrust array and is configured to independently control the rotor speed of each rotor system. During flight operations, the flight control system selectively increases the rotor speed of some of the rotor systems by a speed delta and decreases the rotor speed of others of the rotor systems by the speed delta to avoid generating excitation frequencies by the rotor systems at the critical frequencies. During differential rotor speed resonance avoidance operations, total lateral forces remain unchanged, total fore/aft forces remain unchanged, total altitude forces remain unchanged, total pitch moments remain unchanged, total roll moments remain unchanged and total yaw moments remain unchanged, thereby preserving flight dynamics.

In a third aspect, the present disclosure is directed to an aircraft having a differential rotor speed resonance avoidance system. The aircraft includes an airframe having structural elements subject to resonant vibration at critical frequencies. A thrust array is coupled to the airframe that includes a forward-port rotor system, a forward-starboard rotor system, a mid-port rotor system, a mid-starboard rotor system, an aft-port rotor system and an aft-starboard rotor system. A flight control system is operably associated with the thrust array and is configured to independently control the rotor speed of each rotor system. During flight operations, the flight control system selectively increases the rotor speed of the forward and aft rotor systems on a first side of the aircraft by a first speed delta, decreases the rotor speed of the forward and aft rotor systems on a second side of the aircraft by the first speed delta, decreases the rotor speed of the mid rotor system on the first side of the aircraft by a second speed delta and increases the rotor speed of the mid rotor system on the second side of the aircraft by the second speed delta, to avoid generating excitation frequencies by the rotor systems at the critical frequencies. During differential rotor speed resonance avoidance operations, total lateral forces remain unchanged, total fore/aft forces remain unchanged, total altitude forces remain unchanged, total pitch moments remain unchanged, total roll moments remain unchanged and total yaw moments remain unchanged, thereby preserving flight dynamics.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1F are schematic illustrations of an aircraft having a differential rotor speed resonance avoidance system in accordance with embodiments of the present disclosure;

FIGS. 2A-2H are schematic illustrations of an aircraft having a differential rotor speed resonance avoidance system in a sequential flight operating scenario in accordance with embodiments of the present disclosure;

FIG. 3 is a block diagram of control systems for an aircraft having a differential rotor speed resonance avoidance system in accordance with embodiments of the present disclosure;

FIGS. 4A-4B are a schematic illustration and a block diagram of an aircraft having a differential rotor speed resonance avoidance system in accordance with embodiments of the present disclosure;

FIGS. 5A-5B are a schematic illustration and a block diagram of an aircraft having a differential rotor speed resonance avoidance system in accordance with embodiments of the present disclosure; and

FIG. 6 is a schematic illustration of an aircraft having a differential rotor speed resonance avoidance system in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the term “coupled” may include direct or indirect coupling by any means, including moving and/or non-moving mechanical connections.

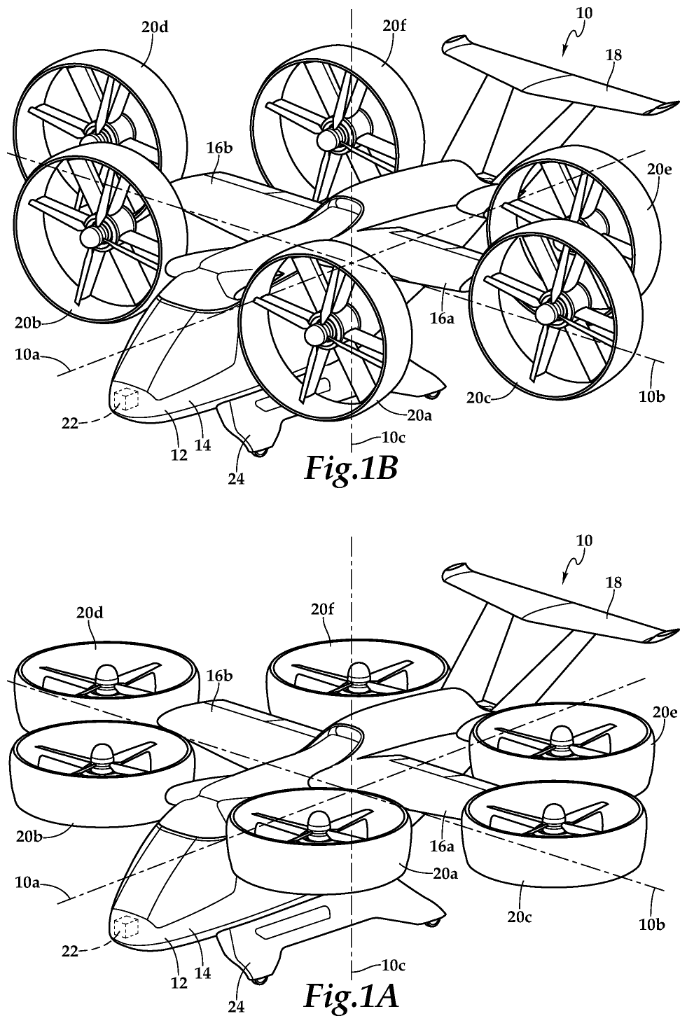

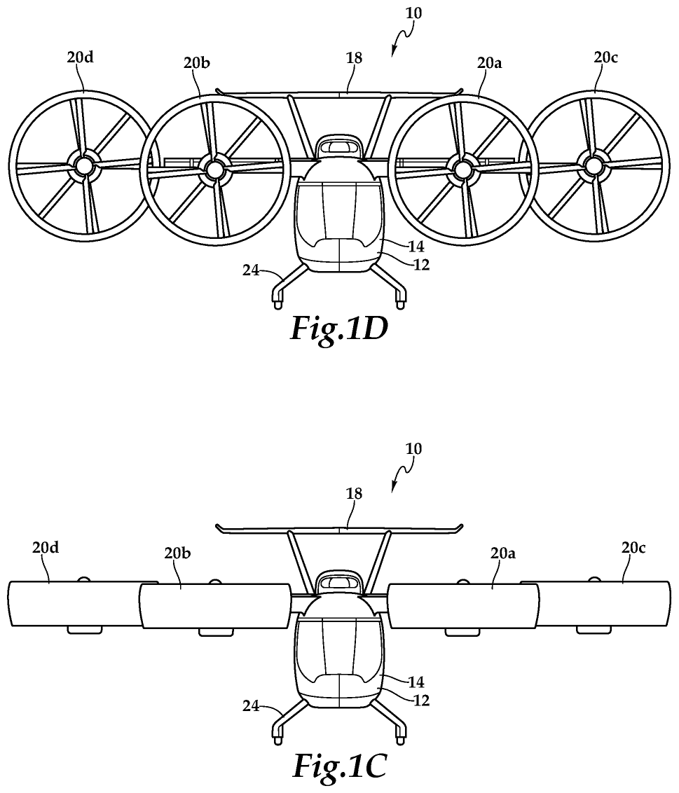

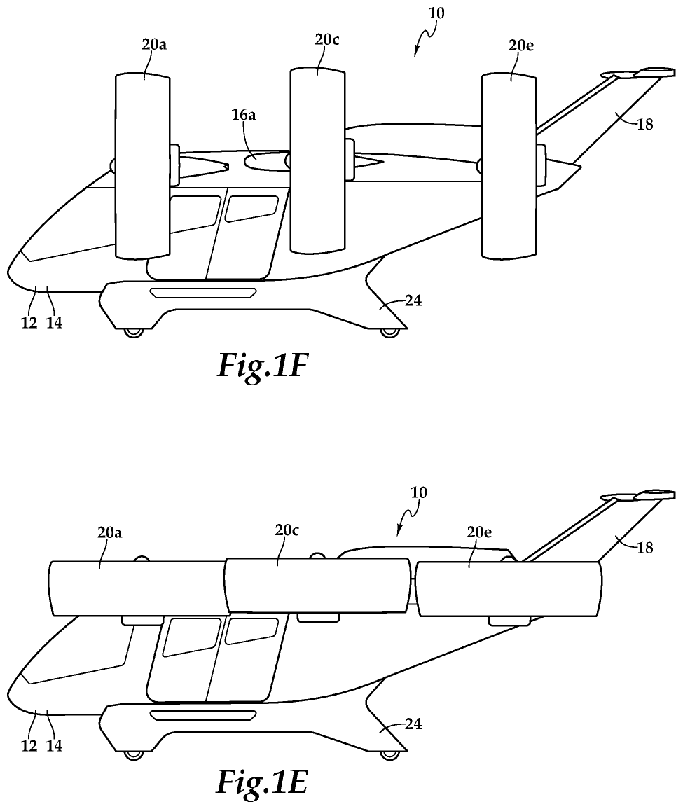

Referring to FIGS. 1A-1G in the drawings, various views of an aircraft 10 having a differential rotor speed resonance avoidance system are depicted. FIGS. 1A, 1C, 1E depict aircraft 10 in a VTOL orientation wherein the rotor systems provide thrust-borne lift. FIGS. 1B, 1D, 1F depict aircraft 10 in a forward flight orientation wherein the rotor systems provide forward thrust with the forward airspeed of aircraft 10 providing wing-borne lift enabling aircraft 10 to have a high speed and/or high endurance forward flight mode. Aircraft 10 has a longitudinal axis 10a that may also be referred to as the roll axis, a lateral axis 10b that may also be referred to as the pitch axis and a vertical axis 10c that may also be referred to as the yaw axis, as best seen in FIGS. 1A and 1B. As illustrated, when longitudinal axis 10a and lateral axis 10b are both in a horizontal plane that is normal to the local vertical in the earth's reference frame, aircraft 10 has a level flight attitude.

In the illustrated embodiment, aircraft 10 has an airframe 12 including a fuselage 14, wings 16a, 16b and a tail assembly 18. Wings 16a, 16b have an airfoil cross-section that generates lift responsive to the forward airspeed of aircraft 10. In the illustrated embodiment, wings 16a, 16b are straight wings with a tapered leading edge. It will be appreciated, however, that wings 16a, 16b may be of a wide variety of shapes, sizes and configurations, depending upon the performance characteristics desired. In the illustrated embodiment, wings 16a, 16b include ailerons to aid in roll and/or pitch control of aircraft 10 during forward flight. Tail assembly 18 is depicted as having a pair of vertical stabilizers that may include one or more rudders to aid in yaw control of aircraft 10 during forward flight. In addition, tail assembly 18 has a horizontal stabilizer that may include one or more elevators to aid in pitch control of aircraft 10 during forward flight. It will be appreciated, however, that tail assembly 18 may be of a wide variety of shapes, sizes and configurations, depending upon the performance characteristics desired.

In the illustrated embodiment, aircraft 10 includes six rotor systems forming a two-dimensional distributed thrust array that is coupled to airframe 12. As used herein, the term “two-dimensional thrust array” refers to a plurality of thrust generating elements that occupy a two-dimensional space in the form of a plane. As used herein, the term “distributed thrust array” refers to the use of multiple thrust generating elements each producing a portion of the total thrust output. The thrust array of aircraft 10 includes a forward-port rotor system 20a, a forward-starboard rotor system 20b, a mid-port rotor system 20c, a mid-starboard rotor system 20d, an aft-port rotor system 20e and an aft-starboard rotor system 20f, which may be referred to collectively as rotor systems 20. Forward-port rotor system 20a and forward-starboard rotor system 20b are each rotatably mounted to a shoulder portion of fuselage 12 at a forward station thereof. Mid-port rotor system 20c is rotatably mounted on the outboard end of wing 16a. Mid-starboard rotor system 20d is rotatably mounted on the outboard end of wing 16b. Aft-port rotor system 20e and aft-starboard rotor system 20f are each rotatably mounted to a shoulder portion of fuselage 12 at an aft station thereof. In the illustrated embodiment, rotor systems 20 are ducted rotor systems each having a four bladed rotor assembly with variable pitch rotor blades operable for collective pitch control. Rotor systems 20 each include at least one variable speed electric motor and a speed controller configured to provide variable speed control to the rotor assembly over a wide range of rotor speeds. In other embodiments, the rotor systems could be non-ducted or open rotor systems, the number of rotor blades could be either greater than or less than four and/or the rotor blades could have a fixed pitch.

When aircraft 10 is operating in the VTOL orientation and supported by thrust-borne lift, rotor systems 20 each have a generally horizontal position such that the rotor assemblies are rotating in generally in the same horizontal plane, as best seen in FIG. 1E. When aircraft 10 is operating in the forward flight orientation and supported by wing-borne lift, rotor systems 20 each have a generally vertical position with the forward rotor assemblies rotating generally in a forward vertical plane, the mid rotor assemblies rotating generally in a mid vertical plane and the aft rotor assemblies rotating generally in an aft vertical plane, as best seen in FIG. 1F. Transitions between the VTOL orientation and the forward flight orientation of aircraft 10 are achieved by changing the angular positions of rotor systems 20 between their generally horizontal positions and the generally vertical positions as discussed herein.

Aircraft 10 includes a liquid fuel powered turbo-generator that includes a gas turbine engine and an electric generator. Preferably, the electric generator charges an array of batteries that provides power to the electric motors of rotor systems 20 via a power management system. In other embodiments, the turbo-generator may provide power directly to the power management system and/or the electric motors of rotor systems 20. In yet other embodiments, rotor systems 20 may be mechanically driven by the power plant of aircraft 10 via suitable gearing, shafting and clutching systems.

Aircraft 10 has a fly-by-wire control system that includes a flight control system 22 that is preferably a redundant digital flight control system including multiple independent flight control computers. Flight control system 22 preferably includes non-transitory computer readable storage media including a set of computer instructions executable by one or more processors for controlling the operation of aircraft 10. Flight control system 22 may be implemented on one or more general-purpose computers, special purpose computers or other machines with memory and processing capability. Flight control system 22 may include one or more memory storage modules including random access memory, non-volatile memory, removable memory or other suitable memory entity. Flight control system 22 may be a microprocessor-based system operable to execute program code in the form of machine-executable instructions. Flight control system 22 may be connected to other computer systems via a suitable communication network that may include both wired and wireless connections.

Flight control system 22 communicates via a wired communications network within airframe 12 with the electronics nodes of each rotor system 20. Flight control system 22 receives sensor data from and sends flight command information to rotor systems 20 such that each rotor system 20 may be individually and independently controlled and operated. For example, flight control system 22 is operable to individually and independently control the rotor speed of each rotor system 20 as well as the angular position of each rotor system 20. Flight control system 22 may autonomously control some or all aspects of flight operation for aircraft 10. Flight control system 22 is also operable to communicate with remote systems, such as a ground station via a wireless communications protocol. The remote system may be operable to receive flight data from and provide commands to flight control system 22 to enable remote flight control over some or all aspects of flight operation for aircraft 10. In addition, aircraft 10 may be pilot operated such that a pilot interacts with a pilot interface that receives flight data from and provide commands to flight control system 22 to enable onboard pilot control over some or all aspects of flight operation for aircraft 10.

Aircraft 10 includes a landing gear 24 for ground operations. Landing gear 24 may include passively operated pneumatic landing struts or actively operated landing struts. In the illustrated embodiment, landing gear 24 includes a plurality of wheels that enable aircraft 10 to taxi and perform other ground maneuvers. Landing gear 24 may include a passive brake system, an active brake system such as an electromechanical braking system and/or a manual brake system to facilitate parking as required during ground operations and/or passenger ingress and egress.

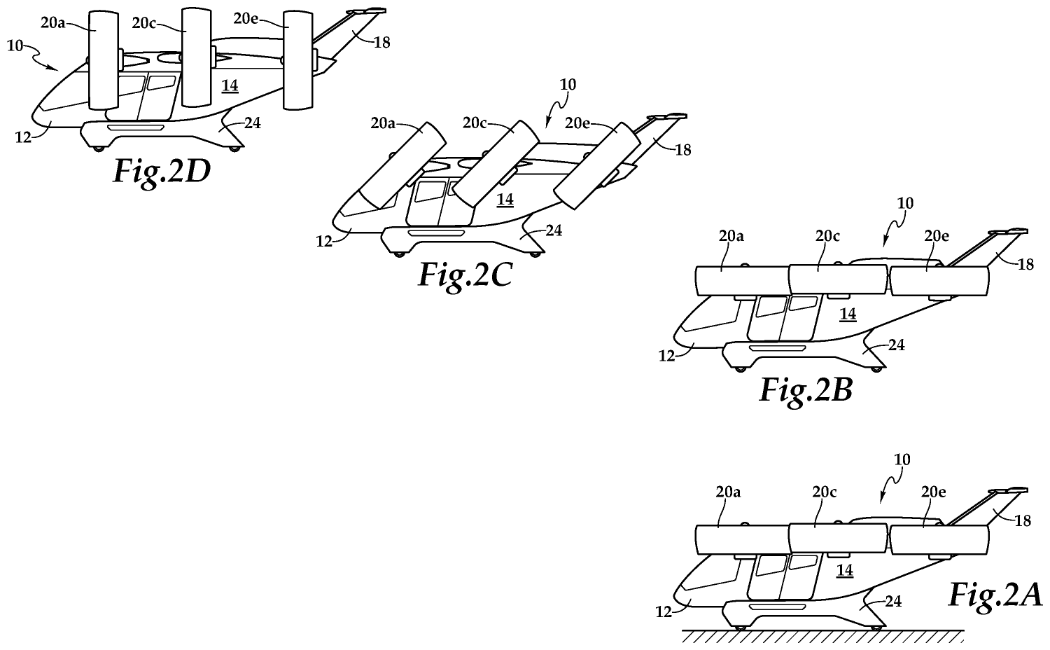

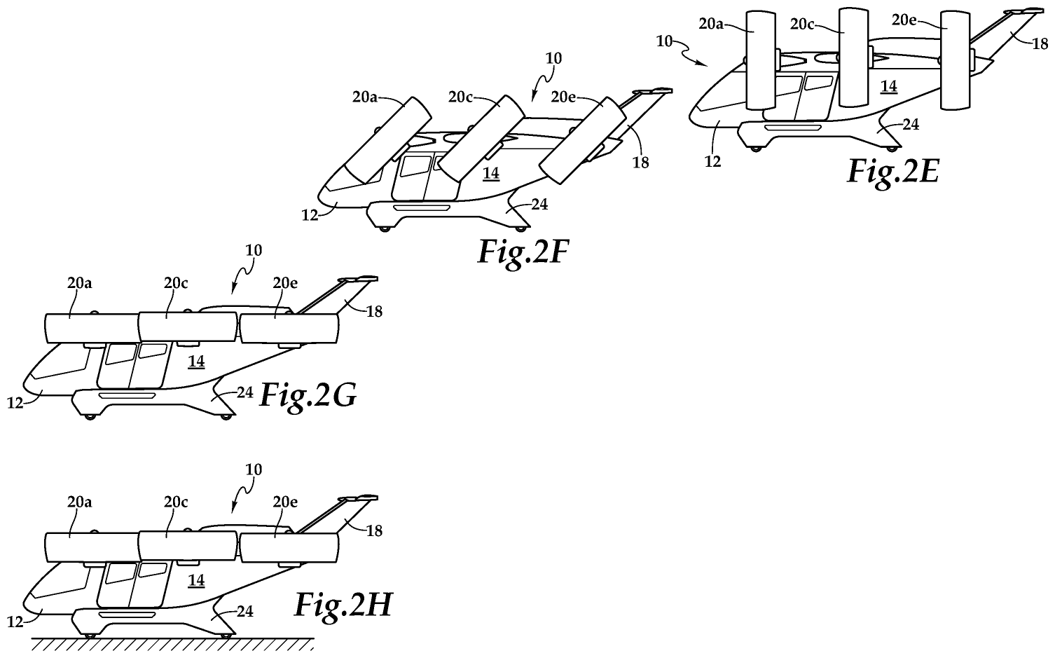

Referring additionally to FIGS. 2A-2H in the drawings, a sequential flight-operating scenario of aircraft 10 is depicted. As best seen in FIG. 2A, aircraft 10 is positioned on the ground prior to takeoff. When aircraft 10 is ready for a mission, flight control system 22 commences operations to provide flight control to aircraft 10 which may be onboard pilot flight control, remote flight control, autonomous flight control or a combination thereof. For example, it may be desirable to utilize onboard pilot flight control during certain maneuvers such as takeoff and landing but rely on autonomous flight control during hover, high speed forward flight and/or transitions between wing-borne flight and thrust-borne flight.

As best seen in FIG. 2B, aircraft 10 has performed a vertical takeoff and is engaged in thrust-borne lift. As illustrated, the rotor assemblies of each rotor system 20 are rotating in the same horizontal plane forming a two-dimensional distributed thrust array of six rotor systems. As the longitudinal axis and the lateral axis of aircraft 10 are both in the horizontal plane, aircraft 10 has a level flight attitude. During hover, flight control system 22 utilizes individual variable speed control capability of rotor systems 20 to control flight dynamics to maintain hover stability and to provide pitch, roll and yaw authority for aircraft 10. More specifically, as each rotor system 20 is independently controllable, operational changes to certain rotor systems 20 enable pitch, roll and yaw control of aircraft 10 during VTOL operations.

For example, by changing the thrust output of forward rotor systems 20a, 20b relative to aft rotor systems 20e, 20f, pitch control is achieved. As another example, by changing the thrust output of port rotor systems 20a, 20c, 20e relative to starboard rotor systems 20b, 20d, 20f, roll control is achieved. Changing the relative thrust outputs of the various rotor systems 20 is preferably accomplished using differential rotor speed control, that is, increasing the rotor speed of some of rotor systems 20 relative to the rotor speed of other rotor systems 20 and/or decreasing the rotor speed of some rotor systems 20 relative to the rotor speed of other rotor systems 20. Yaw control or torque balancing of aircraft 10 during VTOL operations may be accomplished by changing the torque output of certain rotor systems 20. For example, forward-port rotor system 20a, mid-starboard rotor system 20d and aft-port rotor system 20e may have clockwise rotating rotor assemblies while forward-starboard rotor system 20b, mid-port rotor system 20c and aft-starboard rotor system 20f may have counterclockwise rotating rotor assemblies. In this example, by changing the torque output of forward-port rotor system 20a, mid-starboard rotor system 20d and aft-port rotor system 20e relative to forward-starboard rotor system 20b, mid-port rotor system 20c and aft-starboard rotor system 20f, yaw control is achieved. Changing the relative torque outputs of the various rotor systems 20 is preferably accomplished using differential rotor speed control.

Due to the range of desired rotor speeds used by rotor systems 20 of aircraft 10, there is a possibility of operating one or more of the rotor systems 20 at a rotor speed that generates an excitation frequency that could couple with a natural frequency of a structural element of aircraft 10, such as elements of fuselage structure, wing structure, tail structure, rotor system structure or the like. In the event an excitation frequency couples to a natural frequency of one of these structures, the affected structure could become unstable, leading to excessive vibration or even structural failure. In rotorcraft such as aircraft 10, the rotor systems generate excitation frequencies corresponding to 1/rev (1 per revolution), 2/rev, 3/rev, 4/rev and the like. In the illustrated embodiments, the 1/rev excitation frequency and the 4/rev excitation frequency are particularly important as the rotor assemblies each have four rotor blades. Stated another way, the 1/rev and N/rev excitation frequencies for a given rotor system are of particular importance, wherein N is the number of rotor blades in the rotor assembly.

As an example, if a rotor system 20 has an operating speed of 360 RPM, the corresponding 1/rev excitation frequency is 6 Hz, the corresponding 2/rev excitation frequency is 12 Hz, the corresponding 3/rev excitation frequency is 18 Hz and the corresponding 4/rev excitation frequency is 24 Hz. As the operating speed of a rotor system 20 changes, there is a proportional change in the excitation frequencies generated by that rotor system. For example, if a rotor system 20 has an operating speed of 600 RPM, the corresponding 1/rev excitation frequency is 10 Hz, the corresponding 2/rev excitation frequency is 20 Hz, the corresponding 3/rev excitation frequency is 30 Hz and the corresponding 4/rev excitation frequency is 40 Hz. For the present aircraft 10, operating throughout the rotor speed range between 360 RPM and 600 RPM may be desirable depending upon the desired flight dynamics under various flight conditions. If a structural element of aircraft 10 has a critical frequency at, for example, 36 Hz, then it would be desirable not to have any of the rotor systems 20 dwelling at a rotor speed that generates an excitation frequency of 36 Hz or other frequency within the response range of the structural element such as between 35.5 Hz and 36.5 Hz. In this case, the 4/rev excitation frequency of 36 Hz would occur at 540 RPM with the response range being between 532 RPM and 548 RPM.

If it were desired to operate rotor systems 20 of aircraft 10 at 540 RPM for optimum flight dynamics, the 4/rev excitation frequency could couple with the 36 Hz critical frequency resulting in excessive vibration, damage or failure of the structural element. To avoid operating rotor systems 20 at rotor speeds that generate excitation frequencies at such critical frequencies, aircraft 10 utilizes a differential rotor speed resonance avoidance system in which certain of the rotor systems 20 are operated at the desired speed plus a speed delta and certain of the rotor systems 20 are operated at the desired speed minus a speed delta. In the present example, forward-port rotor system 20a, mid-starboard rotor system 20d and aft-port rotor system 20e may be operated at 570 RPM (the desired rotor speed of 540 RPM plus the speed delta of 30 RPM) and forward-starboard rotor system 20b, mid-port rotor system 20c and aft-starboard rotor system 20f may be operated at 510 RPM (the desired rotor speed of 540 RPM minus the speed delta of 30 RPM). In this case, the 4/rev excitation frequencies for the positive speed delta rotor systems are 38 Hz and the 4/rev excitation frequencies for the negative speed delta rotor systems are 34 Hz, which do not correspond with the 36 Hz critical frequency being outside of the 35.5 Hz to 36.5 Hz response range.

During such differential rotor speed resonance avoidance operations, use of complementary positive and negative speed deltas, not only, preserves flight dynamics as total lateral forces remain unchanged, total fore/aft forces remain unchanged, total altitude forces remain unchanged, total pitch moments remain unchanged, total roll moments remain unchanged and total yaw moments remain unchanged, but also, achieves resonance avoidance by not operating any of rotor systems 20 at a rotor speed that generates an excitation frequency corresponding to (at or within the response range of) a critical frequency of a structural element. In this example, operating certain rotor systems 20 at 570 RPM and other rotor systems at 510 RPM preserves flight dynamics and achieves resonance avoidance.

Returning to the sequential flight-operating scenario of aircraft 10, after vertical assent to the desired elevation, aircraft 10 may begin the transition from thrust-borne lift to wing-borne lift. As best seen from the progression of FIGS. 2B-2D, the angular positions of rotor systems 20 are changed by a pitch down rotation to transition aircraft 10 from the VTOL orientation toward the forward flight orientation. As seen in FIG. 2C, rotor systems 20 have been collectively inclined about forty-five degrees pitch down. In the conversion orientations of aircraft 10, a portion of the thrust generated by rotor systems 20 provides lift while a portion of the thrust generated by rotor systems 20 urges aircraft 10 to accelerate in the forward direction such that the forward airspeed of aircraft 10 increases allowing wings 16a, 16b to offload a portion and eventually all of the lift requirement from rotor systems 20. As best seen in FIG. 2D, rotor systems 20 have been collectively inclined about ninety degrees pitch down such that the rotor assemblies are rotating in vertical planes providing forward thrust for aircraft 10 with wings 16a, 16b providing lift. Even though the conversion from the VTOL orientation to the forward flight orientation of aircraft 10 has been described as progressing with collective pitch down rotation of rotor systems 20, in other implementation, all rotor systems 20 need not be operated at the same time or at the same rate.

As forward flight with wing-borne lift requires significantly less thrust than VTOL flight with thrust-borne lift, the operating speed of some or all of rotor systems 20 may be reduced particularly in embodiments having collective pitch control. In certain embodiments, some of rotor systems 20 of aircraft 10 could be shut down during forward flight. In the forward flight orientation, the independent rotor speed control provided by flight control system 22 over each rotor system 20 may provide yaw authority for aircraft 10. For example, by changing the thrust output of one or more port rotor systems 20a, 20c, 20e relative to one or more starboard rotor systems 20b, 20d, 20f, yaw control is achieved. Changing the relative thrust outputs of the various rotor systems 20 is preferably accomplished using differential rotor speed control. In the forward flight orientation, pitch and roll authority is preferably provided by the ailerons and/or elevators on wings 16a, 16b and/or tail assembly 18.

As aircraft 10 approaches its destination, aircraft 10 may begin its transition from wing-borne lift to thrust-borne lift. As best seen from the progression of FIGS. 2E-2G, the angular positions of rotor systems 20 are changed by a pitch up rotation to transition aircraft 10 from the forward flight orientation toward the VTOL orientation. As seen in FIG. 2F, rotor systems 20 have been collectively inclined about forty-five degrees pitch up. In the conversion orientations of aircraft 10, a portion of the thrust generated by rotor systems 20 begins to provide lift for aircraft 10 as the forward airspeed decreases and the lift producing capability of wings 16a, 16b decreases. As best seen in FIG. 2G, rotor systems 20 have been collectively inclined about ninety degrees pitch up such that the rotor assemblies are rotating in the horizontal plane providing thrust-borne lift for aircraft 10. Even though the conversion from the forward flight orientation to the VTOL orientation of aircraft 10 has been described as progressing with collective pitch up rotation of rotor systems 20, in other implementation, all rotor systems 20 need not be operated at the same time or at the same rate. Once aircraft 10 has completed the transition to the VTOL orientation, aircraft 10 may commence its vertical descent to a surface. As best seen in FIG. 2H, aircraft 10 has landing at the destination location.

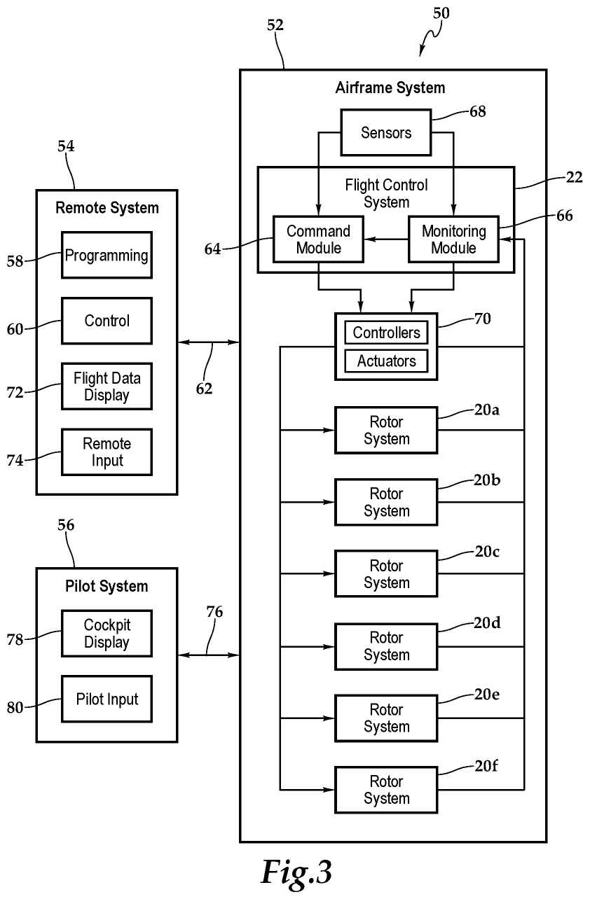

Referring additionally to FIG. 3 in the drawings, a block diagram depicts a control system 50 operable for use with aircraft 10 of the present disclosure. In the illustrated embodiment, system 50 includes three primary computer based subsystems; namely, an airframe system 52, a remote system 54 and a pilot system 56. In some implementations, remote system 54 includes a programming application 58 and a remote control application 60. Programming application 58 enables a user to provide a flight plan and mission information to aircraft 10 such that flight control system 22 may engage in autonomous control over aircraft 10. For example, programming application 58 may communicate with flight control system 22 over a wired or wireless communication channel 62 to provide a flight plan including, for example, a starting point, a trail of waypoints and an ending point such that flight control system 22 may use waypoint navigation during the mission.

In the illustrated embodiment, flight control system 22 is a computer based system that includes a command module 64 and a monitoring module 66. It is to be understood by those skilled in the art that these and other modules executed by flight control system 22 may be implemented in a variety of forms including hardware, software, firmware, special purpose processors and combinations thereof. Flight control system 22 receives input from a variety of sources including internal sources such as sensors 68, controllers and actuators 70 and rotor systems 20a-20f and external sources such as remote system 54 as well as global positioning system satellites or other location positioning systems and the like. During the various operating modes of aircraft 10 including VTOL mode, forward flight mode and transitions therebetween, command module 64 provides commands to controllers and actuators 70. These commands enable independent operation of each rotor system 20a-20f including rotor speed and angular position. Flight control system 22 receives feedback from controllers and actuators 70 and rotor systems 20a-20f. This feedback is processed by monitoring module 66 that can supply correction data and other information to command module 64 and/or controllers and actuators 70. Sensors 68, such as vibration sensors, location sensors, attitude sensors, speed sensors, environmental sensors, fuel sensors, temperature sensors and the like also provide information to flight control system 22 to further enhance autonomous control capabilities.

Some or all of the autonomous control capability of flight control system 22 can be augmented or supplanted by remote flight control from, for example, remote system 54. Remote system 54 may include one or computing systems that may be implemented on general-purpose computers, special purpose computers or other machines with memory and processing capability. Remote system 54 may be a microprocessor-based system operable to execute program code in the form of machine-executable instructions. In addition, remote system 54 may be connected to other computer systems via a proprietary encrypted network, a public encrypted network, the Internet or other suitable communication network that may include both wired and wireless connections. Remote system 54 communicates with flight control system 22 via communication link 62 that may include both wired and wireless connections.

While operating remote control application 60, remote system 54 is configured to display information relating to one or more aircraft of the present disclosure on one or more flight data display devices 72. Remote system 54 may also include audio output and input devices such as a microphone, speakers and/or an audio port allowing an operator to communicate with other operators, a base station and/or a pilot onboard aircraft 10. The display device 72 may also serve as a remote input device 74 if a touch screen display implementation is used, however, other remote input devices, such as a keyboard or joystick, may alternatively be used to allow an operator to provide control commands to an aircraft being operated responsive to remote control.

Some or all of the autonomous and/or remote flight control of aircraft 10 can be augmented or supplanted by onboard pilot flight control from a pilot interface system 56 that includes one or more computing systems that communicate with flight control system 22 via one or more wired communication channels 76. Pilot system 56 preferably includes one or more cockpit display devices 78 configured to display information to the pilot. Cockpit display device 78 may be configured in any suitable form including, for example, a display panel, a dashboard display, an augmented reality display or the like. Pilot system 56 may also include audio output and input devices such as a microphone, speakers and/or an audio port allowing an onboard pilot to communicate with, for example, air traffic control. Pilot system 56 also includes a plurality of user interface devices 80 to allow an onboard pilot to provide control commands to aircraft 10 including, for example, a control panel with switches or other inputs, mechanical control devices such as steering devices or sticks as well as other control devices.

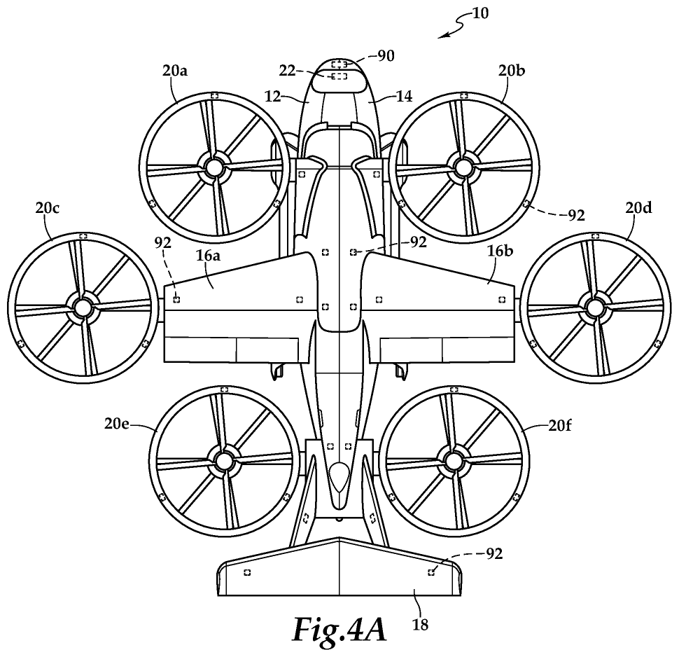

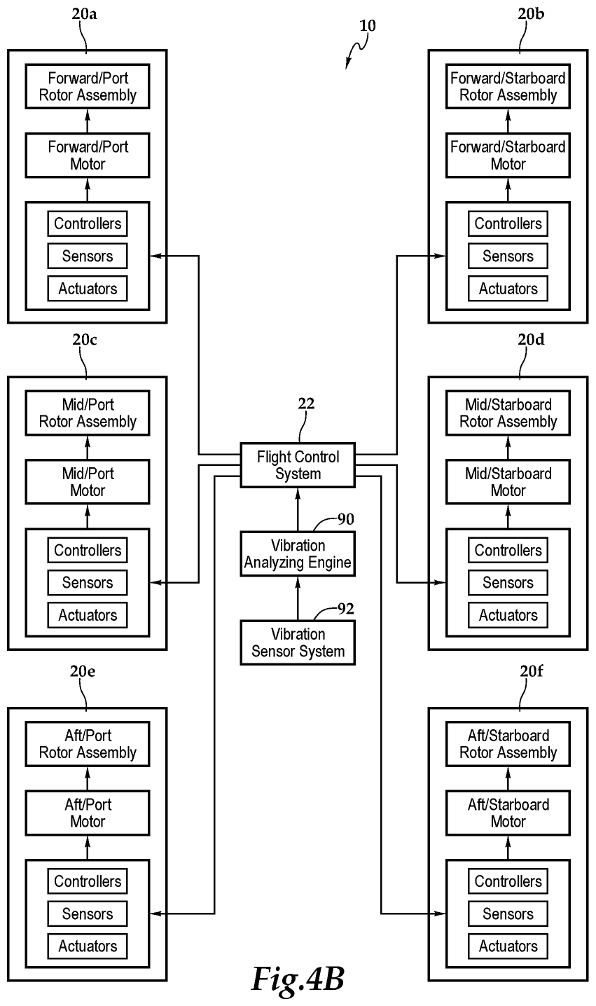

Referring to additionally to FIGS. 4A-4B in the drawings, various views of aircraft 10 having a differential rotor speed resonance avoidance system are depicted. As discussed herein, aircraft 10 includes flight control system 22 and a two-dimensional distributed thrust array depicted as forward-port rotor system 20a, forward-starboard rotor system 20b, mid-port rotor system 20c, mid-starboard rotor system 20d, aft-port rotor system 20e and aft-starboard rotor system 20f. As best seen in FIG. 4B, each rotor system 20 includes an electronics node depicted as having one or more controllers, such as an electronic speed controller, one or more sensors such as vibration sensors and one or more actuators such as a rotor system position actuator and a blade pitch actuator. Each rotor system 20 also includes at least one variable speed electric motor and a rotor assembly coupled to the output drive of the electric motor. As illustrated, rotor systems 20 are ducted rotor systems having variable pitch rotor assemblies with four rotor blades. In the illustrated embodiment, the differential rotor speed resonance avoidance system of aircraft 10 includes a vibration analyzing engine 90 that may be implemented in a variety of forms including hardware, software, firmware, special purpose processors and combinations thereof. Vibration analyzing engine 90 is configured to communicate with flight control system 22. Vibration analyzing engine 90 receives vibration data from a vibration sensor system 92 depicted as including a network of vibration sensors positioned on various elements of aircraft 10 include fuselage 14, wings 16a, 16b, tail assembly 18 and rotor systems 20. The vibration sensors may be accelerometers, such as piezoelectric, solid-state or microelectromechanical systems (MEMS) accelerometers, capable of measuring the acceleration of motion of a structure. Alternatively or additionally, the vibration sensors may be strain gauges, fiber optic sensors or the like.

Flight control system 22 may be preprogrammed with critical frequencies that coincide with the natural frequencies of certain structural elements of aircraft 10. For example, the 36 Hz critical frequency discussed above may have been identified during wind tunnel testing or from previous flight data of aircraft 10 or similar aircraft. Flight control system 22 then uses these critical frequencies as a basis for differential rotor speed resonance avoidance operations. Additionally, vibration sensor system 92 monitors vibrations in real-time during flight operations of aircraft 10. The vibration data is then processed by vibration analyzing engine 90 to identify previously unknown or new critical frequencies that should be avoided. Vibration analyzing engine 90 provides the additional critical frequencies to flight control system 22 enabling implementation of differential rotor speed resonance avoidance operations relating thereto.

As discussed above, the differential rotor speed resonance avoidance system of aircraft 10 utilizes differential rotor speed control wherein certain of the rotor systems 20 are operated at the desired speed S plus a speed delta D and certain of the rotor systems 20 are operated at the desired speed S minus the speed delta D. For the illustrated embodiment, the differential rotor speed resonance avoidance operation could be achieved as follow:

Rotor System 20a operates at S+D;

Rotor System 20b operates at S−D;

Rotor System 20c operates at S−D;

Rotor System 20d operates at S+D;

Rotor System 20e operates at S+D; and

Rotor System 20f operates at S−D.

During differential rotor speed resonance avoidance operations, to preserve flight dynamics, the sums of the forces and moments generated by rotor systems 20 should remain unchanged. In the case of a stable hover, the sums of the forces and moments generated by rotor systems 20 should be zero. Specifically, the sum of the lateral forces generated by rotor systems 20 should remain unchanged (be zero for a stable hover) such that aircraft 10 is not urged to move in the lateral direction. The sum of the fore/aft forces generated by rotor systems 20 should remain unchanged such that aircraft 10 is not urged to move in the longitudinal direction. The sum of the altitude forces generated by rotor systems 20 should remain unchanged such that aircraft 10 is not urged to change elevation. In addition, the sum of the pitch moments generated by rotor systems 20 should remain unchanged such that aircraft 10 is not urged to rotate about lateral axis 10b. The sum of the roll moments generated by rotor systems 20 should remain unchanged such that aircraft 10 is not urged to rotate about longitudinal axis 10a. The sum of the yaw moments generated by rotor systems 20 should remain unchanged such that aircraft 10 is not urged to rotate about vertical axis 10c.

It should be noted that due to the relative position of the rotor systems from the center of gravity of an aircraft and/or the number of rotor systems carried by an aircraft, it may be necessary to have multiple speed deltas in order to preserve flight dynamics. For example, the differential rotor speed resonance avoidance system of aircraft 10 may utilize differential rotor speed control wherein certain of the rotor systems 20 are operated at the desired speed S plus a first speed delta D₁, certain of the rotor systems 20 are operated at the desired speed S minus the first speed delta D₁, certain of the rotor systems 20 are operated at the desired speed S plus a second speed delta D₂ and certain of the rotor systems 20 are operated at the desired speed S minus the second speed delta D₂. In this case, the differential rotor speed resonance avoidance operation could be achieved as follow:

Rotor System 20a operates at S+D₁;

Rotor System 20b operates at S−D₁;

Rotor System 20c operates at S−D₂;

Rotor System 20d operates at S+D₂;

Rotor System 20e operates at S+D₁; and

Rotor System 20f operates at S−D₁.

Due to the number and distribution of rotor systems 20 on aircraft 10, it may be desirable and/or necessary to operate mid rotor systems 20c, 20d at a different speed delta than forward and aft rotor systems 20a, 20b, 20e, 20f such that the sums of the forces and moments generated by rotor systems 20 remain unchanged during differential rotor speed resonance avoidance operations, thereby preserving flight dynamics.

In certain flight scenarios, it may be desirable or necessary to engage in resonance avoidance when it is also desired to have aircraft 10 changing positions such as pitching, rolling or yawing. In these cases, it may be necessary that the speed delta D have both a resonance avoidance component and a flight dynamics component. For example, the differential rotor speed resonance avoidance system of aircraft 10 may utilize differential rotor speed control wherein the rotor systems 20 are operated at the desired speed S plus or minus a speed delta D that includes a resonance avoidance speed delta D_{RA} and a flight dynamics speed delta such as a pitch speed delta D_{P}, a roll speed delta D_{R}, a yaw speed delta D_{Y} and/or combination and permutations thereof. In one such example, if during the differential rotor speed resonance avoidance operation, a pitch up movement is also required, this could be achieved as follow:

Rotor System 20a operates at S+(D_{RA}+D_{P});

Rotor System 20b operates at S−(D_{RA}+D_{P});

Rotor System 20c operates at S−D_{RA};

Rotor System 20d operates at S+D_{RA};

Rotor System 20e operates at S+(D_{RA}−D_{P}); and

Rotor System 20f operates at S−(D_{RA}−D_{P}).

This scenario could also be viewed as having different desired speeds at rotor systems 20 for flight dynamics requirements, which are altered by the resonance avoidance speed delta. Viewed this way, if during a pitch up movement, differential rotor speed resonance avoidance operations are also required, this could be achieved as follow:

Rotor System 20a operates at (S+D_{P})+D_{RA};

Rotor System 20b operates at (S+D_{P})−D_{RA};

Rotor System 20c operates at S−D_{RA};

Rotor System 20d operates at S+D_{RA};

Rotor System 20e operates at (S−D_{P})+D_{RA}; and

Rotor System 20f operates at (S−D_{P})−D_{RA}.

In another example, if during the differential rotor speed resonance avoidance operation, a roll right movement is also required, this could be achieved as follow:

Rotor System 20a operates at S+D_{RA}+D_{R};

Rotor System 20b operates at S−D_{RA}−D_{R};

Rotor System 20c operates at S−D_{RA}+D_{R};

Rotor System 20d operates at S+D_{RA}−D_{R};

Rotor System 20e operates at S+D_{RA}+D_{R}; and

Rotor System 20f operates at S−D_{RA}−D_{R}.

In a further example, if during the differential rotor speed resonance avoidance operation, a clockwise rotational movement is also required, this could be achieved as follow:

Rotor System 20a operates at S+D_{RA}−D_{Y};

Rotor System 20b operates at S−D_{RA} D_{Y};

Rotor System 20c operates at S−D_{RA} D_{Y};

Rotor System 20d operates at S+D_{RA}−D_{Y};

Rotor System 20e operates at S+D_{RA}−D_{Y}; and

Rotor System 20f operates at S−D_{RA} D_{Y}.

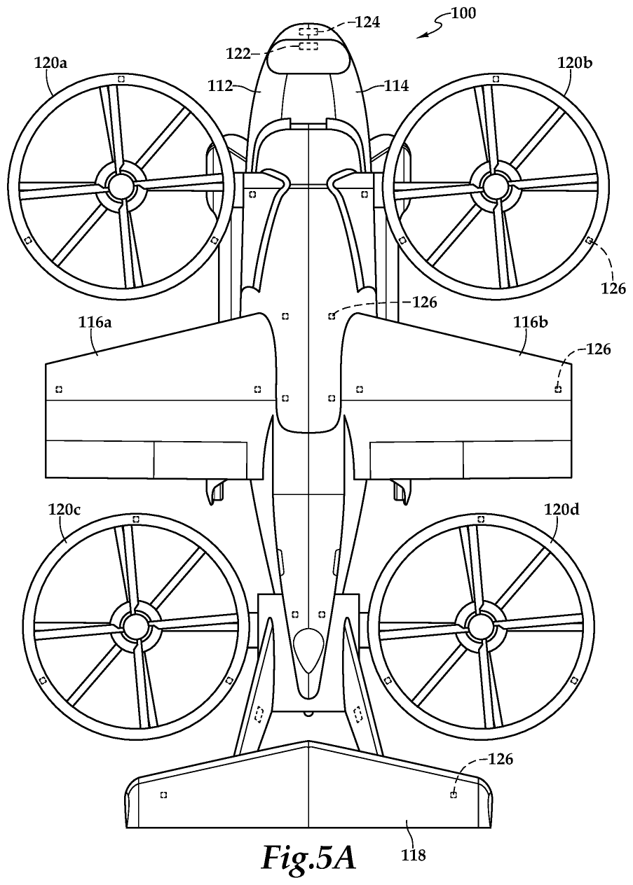

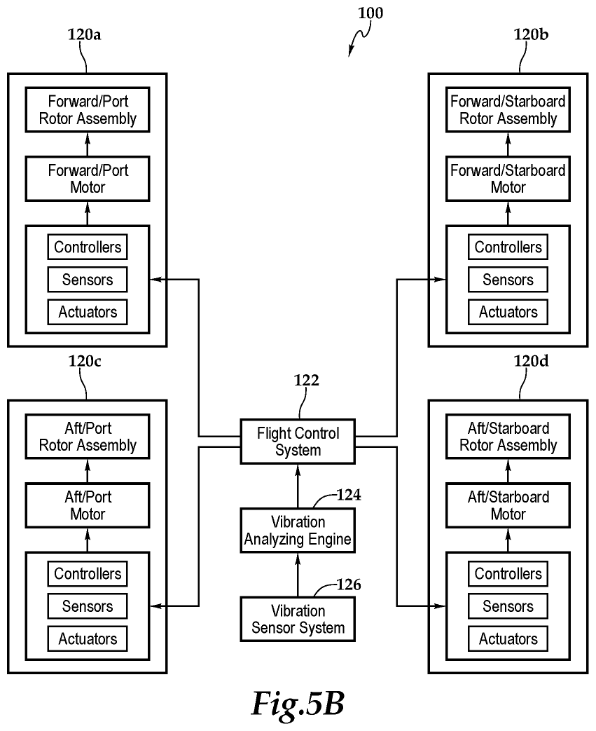

Referring to now to FIGS. 5A-5B in the drawings, various views of an aircraft 100 having a differential rotor speed resonance avoidance system are depicted. Aircraft 100 has an airframe 112 including a fuselage 114, wings 116a, 116b and a tail assembly 118. In the illustrated embodiment, aircraft 100 includes four rotor systems forming a two-dimensional distributed thrust array that is coupled to airframe 112. The two-dimensional distributed thrust array includes a forward-port rotor system 120a, a forward-starboard rotor system 120b, an aft-port rotor system 120c and an aft-starboard rotor system 120d, which may be referred to collectively as rotor systems 120. As best seen in FIG. 5B, each rotor system 120 includes an electronics node depicted as having one or more controllers, one or more sensors and one or more actuators. Each rotor system 120 also includes at least one variable speed electric motor and a rotor assembly coupled to the output drive of the electric motor. In the illustrated embodiment, rotor systems 120 are ducted rotor systems each having a four bladed rotor assembly with variable pitch rotor blades operable for collective pitch control.

Similar to aircraft 10 discussed herein, aircraft 100 is operable to transition between a VTOL orientation with thrust-borne lift and a forward flight orientation with wing-borne lift. Aircraft 100 includes a liquid fuel powered turbo-generator that includes a gas turbine engine and an electric generator that charges an array of batteries that provides power to the electric motors of rotor systems 120 via a power management system. Aircraft 100 has a fly-by-wire control system that includes a flight control system 122 that communicates via a wired communications network within airframe 112 with the electronics nodes of each rotor system 120. Flight control system 122 receives sensor data from and sends flight command information to rotor systems 120 such that each rotor system 120 may be individually and independently controlled and operated including the rotor speed and angular position of each rotor system 120. Flight control system 122 may operate responsive to autonomously flight control, remote flight control, onboard pilot flight control or combinations thereof.

In the illustrated embodiment, the differential rotor speed resonance avoidance system of aircraft 100 includes a vibration analyzing engine 124 that is configured to communicate with flight control system 122. Vibration analyzing engine 124 receives vibration data from a vibration sensor system 126 depicted as a network of vibration sensors positioned on various elements of aircraft 100 include fuselage 114, wings 116a, 116b, tail assembly 118 and rotor systems 210. Flight control system 122 may be preprogrammed with critical frequencies that coincide with the natural frequencies of certain structural elements of aircraft 100. Additionally, vibration sensor system 126 monitors vibrations in real-time during flight operations of aircraft 100. The vibration data is then processed by vibration analyzing engine 124 to identify previously unknown or new critical frequencies that should be avoided. Vibration analyzing engine 124 provides the additional critical frequencies to flight control system 122 enabling implementation of differential rotor speed resonance avoidance operations relating thereto.

The differential rotor speed resonance avoidance system of aircraft 100 utilizes differential rotor speed control wherein certain of the rotor systems 120 are operated at the desired speed S plus a speed delta D and certain of the rotor systems 120 are operated at the desired speed S minus the speed delta D. For the illustrated embodiment, the differential rotor speed resonance avoidance operation could be achieved as follow:

Rotor System 20a operates at S+D;

Rotor System 20b operates at S−D;

Rotor System 20c operates at S−D; and

Rotor System 20d operates at S+D.

During differential rotor speed resonance avoidance operations, to preserve flight dynamics, the sums of the forces and moments generated by rotor systems 120 should remain unchanged and should be zero in the case of a stable hover. Specifically, each of the sums of the lateral forces, the fore/aft forces, the altitude forces, the pitch moments, the roll moments and the yaw moments generated by rotor systems 120 should remain unchanged (be zero for a stable hover) such that aircraft 100 is not urged to move in any direction. In certain flight scenarios, it may be desirable or necessary to engage in resonance avoidance when it is also desired to have aircraft 100 changing positions such as pitching, rolling or yawing. In these cases, it may be necessary that the speed delta D have both a resonance avoidance component and a flight dynamics component, as discussed herein.

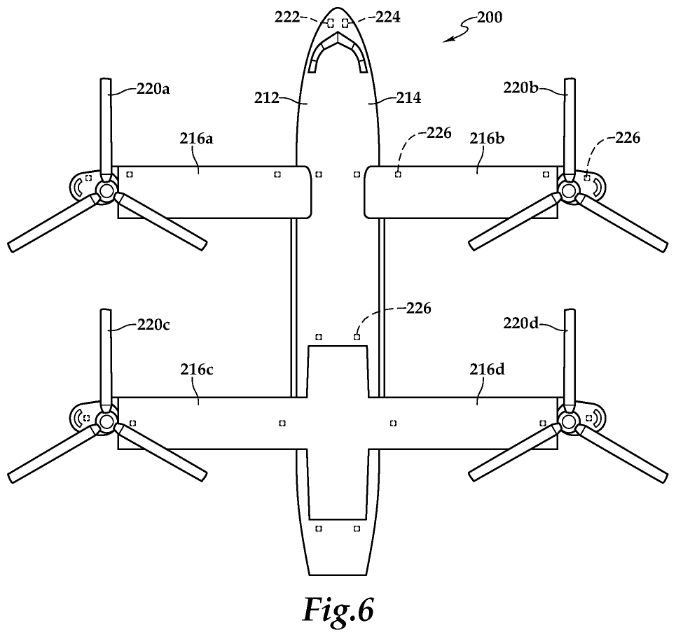

It should be appreciated that aircraft 10, 100 are merely illustrative of a variety of aircraft that can implement the embodiments disclosed herein. Indeed, the differential rotor speed resonance avoidance system of the present disclosure may be implemented on a variety of multirotor aircraft. Other aircraft implementations can include hybrid aircraft, tiltwing aircraft, unmanned aircraft, drones and the like. For example, as best seen in FIG. 6, a quad tiltrotor aircraft having a differential rotor speed resonance avoidance system is depicted and generally designated 200. Aircraft 200 has an airframe 212 including a fuselage 214 and wings 216a, 216b, 216c, 216d. Aircraft 200 includes four rotor systems forming a two-dimensional distributed thrust array that is coupled to airframe 212. The two-dimensional distributed thrust array includes a forward-port rotor system 220a rotatably mounted to an outboard end of wing 216a, a forward-starboard rotor system 220b rotatably mounted to an outboard end of wing 216b, an aft-port rotor system 220c rotatably mounted to an outboard end of wing 216c and an aft-starboard rotor system 220d rotatably mounted to an outboard end of wing 216d. In the illustrated embodiment, rotor systems 220 are open rotor systems each having a three bladed rotor assembly with variable pitch rotor blades operable for collective pitch control.

Aircraft 200 is operable to transition between a VTOL orientation with thrust-borne lift and a forward flight orientation with wing-borne lift responsive to rotation of rotor systems 220 relative to wings 216. Aircraft 200 has a fly-by-wire control system that includes a flight control system 222 that communicates via a wired communications network within airframe 212 with the electronics nodes of each rotor system 220. Flight control system 222 receives sensor data from and sends flight command information to rotor systems 220 such that each rotor system 220 may be individually and independently controlled and operated including the rotor speed and angular position of each rotor system 220. Flight control system 222 may operate responsive to autonomously flight control, remote flight control, onboard pilot flight control or combinations thereof.

In the illustrated embodiment, the differential rotor speed resonance avoidance system of aircraft 200 includes a vibration analyzing engine 224 that is configured to communicate with flight control system 222. Vibration analyzing engine 224 receives vibration data from a vibration sensor system 226 depicted as a network of vibration sensors positioned on various elements of aircraft 200 include fuselage 214, wings 216a-216d and rotor systems 210. Flight control system 222 may be preprogrammed with critical frequencies that coincide with the natural frequencies of certain structural elements of aircraft 200. Additionally, vibration sensor system 226 monitors vibrations in real-time during flight operations of aircraft 200. The vibration data is then processed by vibration analyzing engine 224 to identify previously unknown or new critical frequencies that should be avoided. Vibration analyzing engine 224 provides the additional critical frequencies to flight control system 222 enabling implementation of differential rotor speed resonance avoidance operations relating thereto.

The differential rotor speed resonance avoidance system of aircraft 200 utilizes differential rotor speed control wherein the rotor systems 220 are operated at the desired speed S plus or minus a speed delta D. For the illustrated embodiment, the differential rotor speed resonance avoidance operation could be achieved as follow:

Rotor System 20a operates at S+D;

Rotor System 20b operates at S−D;

Rotor System 20c operates at S−D; and

Rotor System 20d operates at S+D.

During differential rotor speed resonance avoidance operations, to preserve flight dynamics, the sums of the forces and moments generated by rotor systems 220 should remain unchanged and should be zero in the case of a stable hover. Specifically, each of the sums of the lateral forces, the fore/aft forces, the altitude forces, the pitch moments, the roll moments and the yaw moments generated by rotor systems 220 should remain unchanged (be zero for a stable hover) such that aircraft 200 is not urged to move in any direction. In certain flight scenarios, it may be desirable or necessary to engage in resonance avoidance when it is also desired to have aircraft 200 changing positions such as pitching, rolling or yawing. In these cases, it may be necessary that the speed delta D have both a resonance avoidance component and a flight dynamics component, as discussed herein.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. An aircraft having a differential rotor speed resonance avoidance system, the aircraft comprising:
an airframe including structural elements subject to resonant vibration at critical frequencies;
a thrust array coupled to the airframe, the thrust array including at least four rotor systems distributed about the airframe, each rotor system operable over a range of rotor speeds; and
a flight control system operably associated with the thrust array and configured to independently control the rotor speed of each rotor system;
wherein, while preserving flight dynamics during flight operations, the flight control system selectively increases the rotor speed of some of the rotor systems by a speed delta and decreases the rotor speed of others of the rotor systems by the speed delta to avoid generating excitation frequencies by the rotor systems at the critical frequencies.

2. The aircraft as recited in claim 1 wherein the at least four rotor systems further comprise a forward-port rotor system, a forward-starboard rotor system, an aft-port rotor system and an aft-starboard rotor system.

3. The aircraft as recited in claim 1 wherein the at least four rotor systems further comprise six rotor systems including a forward-port rotor system, a forward-starboard rotor system, a mid-port rotor system, a mid-starboard rotor system, an aft-port rotor system and an aft-starboard rotor system.

4. The aircraft as recited in claim 1 wherein the rotor systems further comprise ducted rotor systems or open rotor systems.

5. The aircraft as recited in claim 1 wherein the structural element subject to resonant vibration are selected from the group consisting of fuselage structure, wing structure, tail structure or rotor system structure.

6. The aircraft as recited in claim 1 wherein the rotor systems further comprise rotor blades selected from the group consisting of fixed pitch rotor blades or variable pitch rotor blades.

7. The aircraft as recited in claim 1 wherein the speed delta further comprises a first speed delta and a second speed delta; and
wherein the flight control system increases the rotor speed of at least two rotor systems by the first speed delta, decreases the rotor speed of at least two rotor systems by the first speed delta, increases the rotor speed of at least one rotor system by the second speed delta and decreases the rotor speed of at least one rotor system by the second speed delta to avoid generating excitation frequencies by the rotor systems at the critical frequencies.

8. The aircraft as recited in claim 1 wherein the speed delta further comprises a resonance avoidance component and a pitch component.

9. The aircraft as recited in claim 1 wherein the speed delta further comprises a resonance avoidance component and a roll component.

10. The aircraft as recited in claim 1 wherein the speed delta further comprises a resonance avoidance component and a yaw component.

11. The aircraft as recited in claim 1 wherein, during differential rotor speed resonance avoidance operations, total lateral forces remain unchanged, thereby preserving flight dynamics.

12. The aircraft as recited in claim 1 wherein, during differential rotor speed resonance avoidance operations, total fore/aft forces remain unchanged, thereby preserving flight dynamics.

13. The aircraft as recited in claim 1 wherein, during differential rotor speed resonance avoidance operations, total altitude forces remain unchanged, thereby preserving flight dynamics.

14. The aircraft as recited in claim 1 wherein, during differential rotor speed resonance avoidance operations, total pitch moments remain unchanged, thereby preserving flight dynamics.

15. The aircraft as recited in claim 1 wherein, during differential rotor speed resonance avoidance operations, total roll moments remain unchanged, thereby preserving flight dynamics.

16. The aircraft as recited in claim 1 wherein, during differential rotor speed resonance avoidance operations, total yaw moments remain unchanged, thereby preserving flight dynamics.

17. The aircraft as recited in claim 1 wherein the critical frequencies are preprogrammed into the flight control system.

18. The aircraft as recited in claim 1 further comprising:
a vibration sensor system position on the aircraft; and
a vibration analyzing engine configured to receive vibration data from the vibration sensor system during flight and to identify critical frequencies for the flight control system.

19. An aircraft having a differential rotor speed resonance avoidance system, the aircraft comprising:
an airframe including structural elements subject to resonant vibration at critical frequencies;
a thrust array coupled to the airframe, the thrust array including a forward-port rotor system, a forward-starboard rotor system, an aft-port rotor system and an aft-starboard rotor system; and
a flight control system operably associated with the thrust array and configured to independently control the rotor speed of each rotor system;
wherein, during flight operations, the flight control system selectively increases the rotor speed of some of the rotor systems by a speed delta and decreases the rotor speed of others of the rotor systems by the speed delta to avoid generating excitation frequencies by the rotor systems at the critical frequencies; and
wherein, during differential rotor speed resonance avoidance operations, total lateral forces remain unchanged, total fore/aft forces remain unchanged, total altitude forces remain unchanged, total pitch moments remain unchanged, total roll moments remain unchanged and total yaw moments remain unchanged, thereby preserving flight dynamics.

20. An aircraft having a differential rotor speed resonance avoidance system, the aircraft comprising:
an airframe including structural elements subject to resonant vibration at critical frequencies;
a thrust array coupled to the airframe, the thrust array including a forward-port rotor system, a forward-starboard rotor system, a mid-port rotor system, a mid-starboard rotor system, an aft-port rotor system and an aft-starboard rotor system; and
a flight control system operably associated with the thrust array and configured to independently control the rotor speed of each rotor system;
wherein, during flight operations, the flight control system selectively increases the rotor speed of the forward and aft rotor systems on a first side of the aircraft by a first speed delta, decreases the rotor speed of the forward and aft rotor systems on a second side of the aircraft by the first speed delta, decreases the rotor speed of the mid rotor system on the first side of the aircraft by a second speed delta and increases the rotor speed of the mid rotor system on the second side of the aircraft by the second speed delta, to avoid generating excitation frequencies by the rotor systems at the critical frequencies; and
wherein, during differential rotor speed resonance avoidance operations, total lateral forces remain unchanged, total fore/aft forces remain unchanged, total altitude forces remain unchanged, total pitch moments remain unchanged, total roll moments remain unchanged and total yaw moments remain unchanged, thereby preserving flight dynamics.
